(19) United States
(12) Patent Application Publication
(10) Pub. No.: US 2005/0045111 A1
(43) Pub. Date: Mar. 3, 2005

(54) Feeding box for small animal

(76) Inventor: Jun Hui Lin, Taipei (TW)

Correspondence Address: Jun Hui Lin, PO Box 82-144, Taipei, TW

(21) Appl. No.: 10/651,952

(22) Filed: Sep. 2, 2003

(51) Int. Cl. A01K 1/10

(52) U.S. Cl. 119/61.5

(57) ABSTRACT

A structure of a feeding box for animals, wherein the box is provided with a rear section having an elongated hanging lug for mounting closely onto the bottom edge at the lower opening of a casing for keeping small animals and the inner side of the body is alternately arranged with a plurality of horizontal and vertical partition boards to form a slot for holding feeds or water, or a plurality of small cavities.

### BACKGROUND OF THE INVENTION

(a) Technical Field of the Invention

The present invention relates to feeding box, and in particular, to a box body provided with elongated hanging lugs and the interior of the box being partitioned to form a plurality of slots.

(b) Description of the Prior Art

FIGS. 1, 2 and 3 are perspective and exploded view of a conventional feeding box. The feeding box 1 is a semi-circular and there is a hanging lug 11 at the rear section close to the center of the two lateral sides. By using the hook like hanging lug 11, the feeding box 1 is hang to a casing 2, which is provided with a moving door 22 and an opening 21 with a bottom edge section 211. The conventional feeding box not has hanging lug 11 and the area for suspension is small and therefore, the box 1 will swing from left to right. Further, the area of the feeding slot 12 is small and the depth is shallow and the weight of the feeding box is light, the box is very easily toppled by the small animal. As a result, the feedings are thus wasted and it is laborious to wash the casing. FIG. 3 is another conventional feeding box 3 having provided with blocking lug 31. There are two feeding slot 32 within the feeding box 3 for holding feeds and water. This conventional feeding box has the same drawbacks. Accordingly it is an object of the present invention to provide a feeding box for small animal which mitigates the above drawbacks.

### SUMMARY OF THE INVENTION

Accordingly, it is an object of the present invention to provide a structure of a feeding box for small animal characterized in that the rear section of the body of the feeding box is provided with an elongated hanging lug for mounting closely onto the bottom edge at the lower opening of a casing for keeping small animal, and the inmer side of the body is alternately arranged with a plurality of horizontal and vertical partition boards to form a slot for holding feeds or water, or a plurality of small cavities.

Yet a further object of the present invention is to provide a feeding box for small animal, wherein the hanging of the box to the case is stable and the box is washable and is easily operated.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a conventional feeding box hanging onto a case.

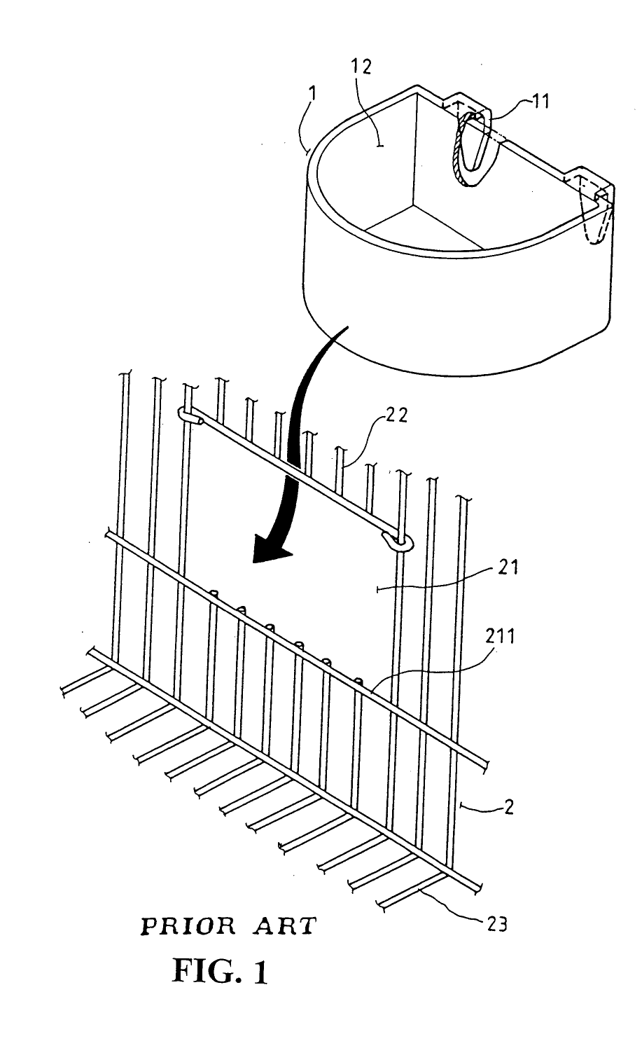

FIG. 2 is a perspective view showing the mounting of a conventional feeding box to a case.

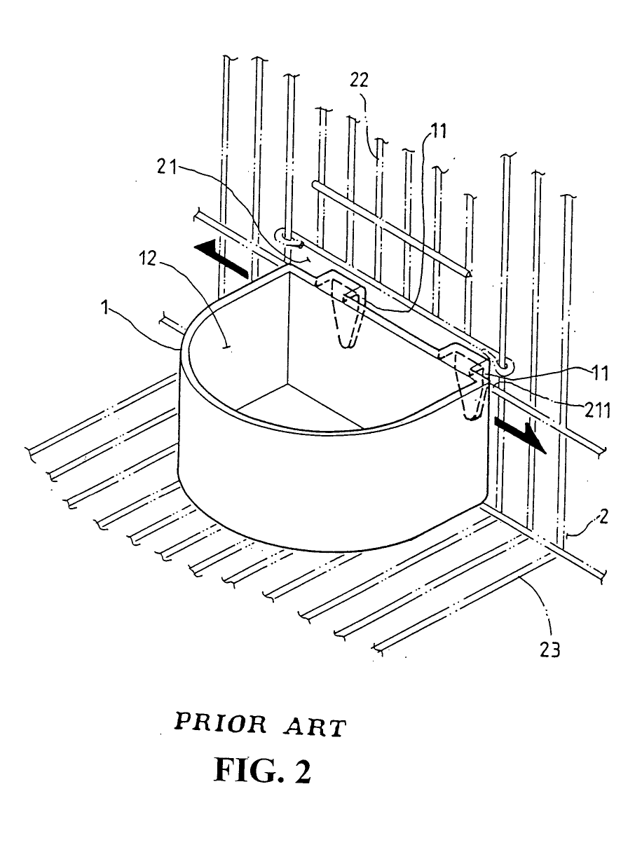

FIG. 3 is another example of a conventional feeding box.

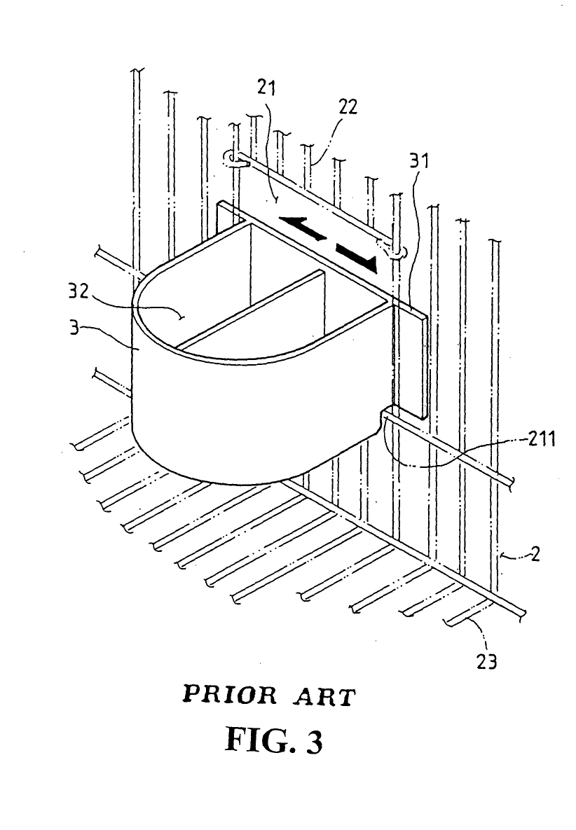

FIG. 4 is a perspective exploded view of the feeding box mounting onto a casing in accordance with the present invention.

FIG. 5 is a perspective view of the feeding box mounting onto a casing in accordance with the present invention.

FIG. 6 is a side view of the feeding box mounting onto a casing in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

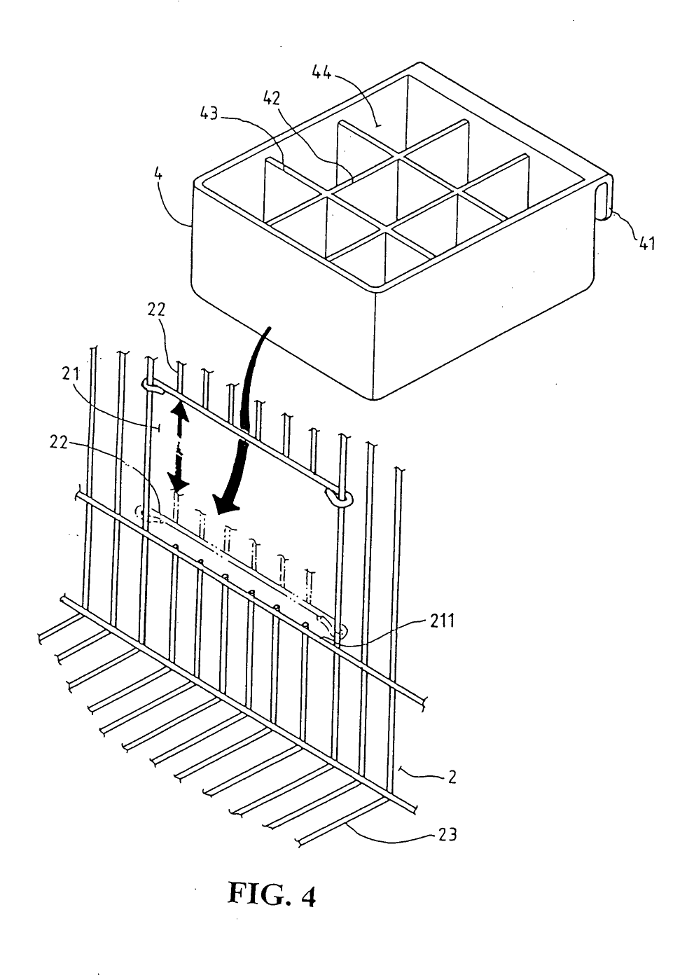

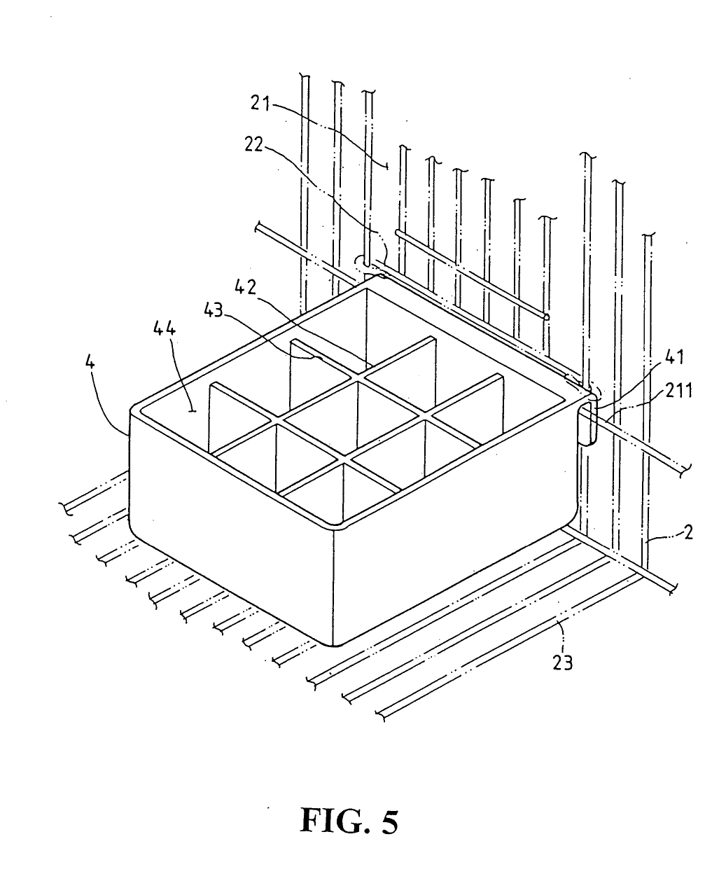

Referring to FIGS. 4 and 5, there is shown a feeding box having a box body 4 mounted onto a casing 2. In accordance with the present invention, the rear section of the body 4 is provided with an elongated hanging lug 41. The inner side of the body 4 is arranged alternately with a plurality of vertical partition plates 42 and horizontal plates 43. The interior of the body is formed into a plurality of small slots 44. The use of the elongated lug 41 is to provide hooking of the feeding box at the bottom edge section 211 of the opening 21 of the casing 2. The rear section is closely adhered onto the casing 2. Thus, the hanging lug 41 is firmly hooked to the opening 21. Accordingly, the feeding box can be easily washed or operated and the feeding box will not swing to left or right position.

Further, the top portion of the body is restricted by the moving door 22. The bottom section of the body 4 is in contact with the bottom 23 of the casing, and therefore the left right or up and down movement of the body is restricted.

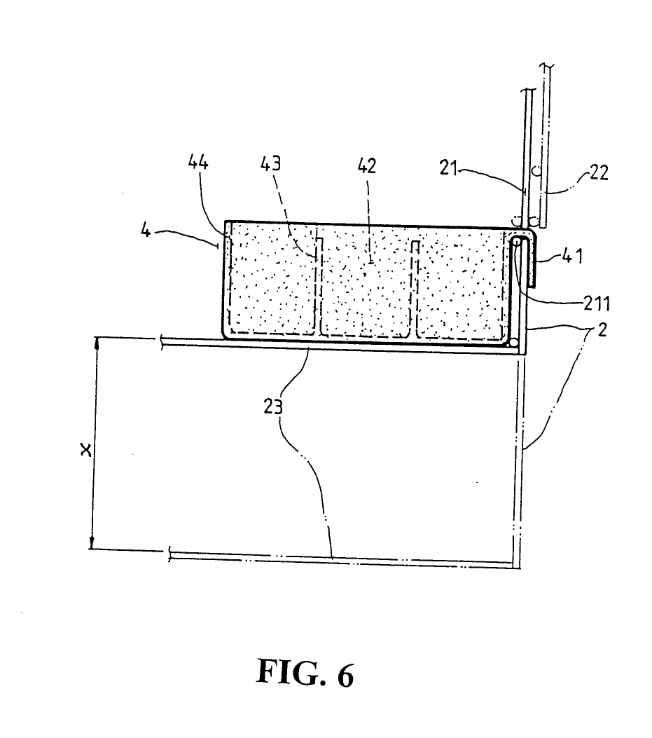

As shown in FIG. 6, there is shown a side view of the casing 2 together with the feeding box. The interior of the body 4 is provided with a plurality of vertical and horizontal partition plates 42, 43 alternately arranged to form a plurality of small slots 44. Small animals will not fall to the feeding box as that of the conventional feeding box 12, 32. The alternately arranged partition plates 42, 43 within the body 4 are formed into a plurality of small slots 44. If water or feedings are placed in the feeding box of the present invention, the feeding box will be heavy and will not be toppled. As shown in FIGS. 5 and 6, the bottom position of the body 4 is located at the casing bottom 23, if the distance between the casing bottom 23 and the bottom of the body increases, as shown in dotted lines in FIG. 6, the body 4 is similarly stable. Thus, when the body 4 is to be accessed, the feeding box has to be lifted up the hanging lug 41 and the bottom edge section have to be separated, and the feeding box is withdrawn from the opening 21.

It will be understood that each of the elements described above, or two or more together may also find a useful application in other types of methods differing from the type described above.

While certain novel features of this invention have been shown and described and are pointed out in the annexed claim it is not intended to be limited to the details above, since it will be understood that various omissions, modifications, substitutions and changes in the formns and details of the device illustrated and in its operation can be made by those skilled in the art without departing in any way from the spirit of the present invention.

1. (canceled)

2. A feeding box for feeding animals comprising a box body mounted onto a casing, said box body having a rear section provided with an elongated hanging lug, said box body having an inner side arranged alternately with a plurality of vertical partition plates and horizontal plates, said box body having an interior formed into a plurality of slots, said elongated lug providing hooking of said feeding box at a bottom edge section of an opening of said casing, said rear section being closely adhered onto said casing, said hanging lug being firmly hooked to said opening, a top portion of said body being restricted by a moving door movably mounted on said casing, a bottom section of said body being in contact with a bottom of said casing.
